(19) United States
(12) Patent Application Publication
(10) Pub. No.: US 2013/0209862 A1
(43) Pub. Date: Aug. 15, 2013

(54) Battery Comprising a Plurality of Independent Battery Cell Lines

(71) Applicants: Stefan Butzmann, Beilstein (DE); Holger Fink, Stuttgart (DE)

(72) Inventors: Stefan Butzmann, Beilstein (DE); Holger Fink, Stuttgart (DE)

(73) Assignees: SB LiMotive Germany Gmbh, Stuttgart (DE); SB LiMotive Company Ltd, Yongin-si Gyeonggi-do (KR)

(21) Appl. No.: 13/641,626

(22) PCT Filed: Feb. 16, 2011
(86) PCT No.: PCT/EP2011/052255

§ 371 Date: Feb. 4, 2013

(30) Foreign Application Priority Data
Apr. 16, 2010 (DE) 102010027851.3

(51) Int. Cl. H01M 2/20; B60L 11/18

(52) U.S. Cl. CPC H01M 2/202; B60L 11/18
USPC 429/156

(57) ABSTRACT

A motor vehicle includes an electric drive motor for driving the motor vehicle and a battery connected to the electric drive motor. The battery includes a plurality of battery cell lines, each battery cell line has a plurality of battery cells mounted in series between a respective first pole and a respective second pole.

The present invention relates to a battery having a plurality of independent battery cell lines and an electric motor vehicle having such a battery.

### PRIOR ART

It has become apparent that in future battery systems will be increasingly used both for stationary applications and vehicles such as hybrid vehicles and electric vehicles. In order to be able to meet the requirements in terms of voltage and available power which are made of the respective application, a large number of battery cells are connected in series. Since the current which is made available by such a battery must flow through all the battery cells and a battery cell can only conduct a limited current, battery cells are often additionally connected in parallel in order to increase the maximum current. This can either be done by providing a plurality of cell windings within a battery cell housing or by externally connecting battery cells. However, it is problematic here that owing to cell capacities and cell voltages which are not precisely identical, compensating currents may occur between the battery cells which are connected in parallel.

FIG. 1 illustrates a basic circuit diagram of a customary electric drive system such as is used, for example, in electric vehicles and hybrid vehicles or else in stationary applications such as for the adjustment of rotor blades of wind turbine plants. A battery 10 is connected to a direct voltage intermediate circuit which is buffered by a capacitor 11. A pulse-controlled inverter 12 is connected to the direct voltage intermediate circuit, which pulse-controlled inverter 12 makes available, via two switchable semiconductor valves and two diodes in each case, sinusoidal voltages which are phase-shifted with respect to one another for operating an electric drive motor 13, at three outputs. The capacity of the capacitor 11 must be large enough to stabilize the voltage in the direct voltage intermediate circuit for a time period in which one of the switchable semiconductor valves is connected through. In a practical application, such as an electric vehicle, a large capacity in the region of mF occurs. Because of the usually fairly high voltage of the direct voltage intermediate circuit, such a large capacity can only be implemented at high cost and with a large spatial requirement.

### DISCLOSURE OF THE INVENTION

According to the invention, a battery having a plurality of battery cell lines, each of which contains a plurality of battery cells which are connected in series between a respective first pole and a respective second pole, is therefore introduced.

The battery of the invention has the advantage that the total capacity of the battery is distributed among battery cell lines which are independent of one another, as a result of which compensating currents can no longer occur between the battery cells and battery cell lines. If such a battery is connected to a pulse-controlled inverter which has a number of pairs of inputs corresponding to the number of battery cell lines of the battery, the necessary capacity of the buffer capacitors which are to be respectively connected to the pairs of inputs of the pulse-controlled inverter can be reduced. For specific applications and dimensions the buffer capacitors can, under certain circumstances, be eliminated completely.

The battery preferably comprises precisely three battery cell lines. Such a battery is particularly suitable for driving electric motors which usually require three phase-shifted sinusoidal voltages for operation.

Each first pole of the plurality of battery cell lines can be conductively connected to a respective first battery terminal. The respective first battery terminals permit the battery to be connected to a pulse-controlled inverter with a correspondingly large number of pairs of inputs.

In one embodiment of the invention, the second poles of the battery cell lines can be conductively connected to one another. The second poles which are connected to one another therefore constitute a reference potential which can be connected, for example, to the vehicle ground, for which purpose the second poles of the battery cell lines can be conductively connected to a second battery terminal. Alternatively, every second pole of the plurality of battery cell lines can be conductively connected to a respective second battery terminal.

The first poles of the plurality of battery cell lines can be positive battery poles, and the second poles of the plurality of battery cell lines can be negative battery poles.

The battery cells are preferably lithium-ion battery cells. Lithium-ion battery cells have the advantage of a high cell voltage and of a particularly high capacity per volume.

The battery may have a battery housing in which the plurality of battery cell lines is arranged.

A second aspect of the invention concerns a motor vehicle having an electric drive motor for driving the motor vehicle and a battery connected to the electric drive motor according to the first aspect of the invention.

### DRAWINGS

Exemplary embodiments of the invention are explained in more detail with reference to the drawings and the following description, in which:

FIG. 1 shows an electric drive system according to the prior art,

FIG. 2 shows a first exemplary embodiment of the invention,

FIG. 3 shows a second exemplary embodiment of the invention, and

FIG. 4 shows an electric drive system having a battery according to the invention.

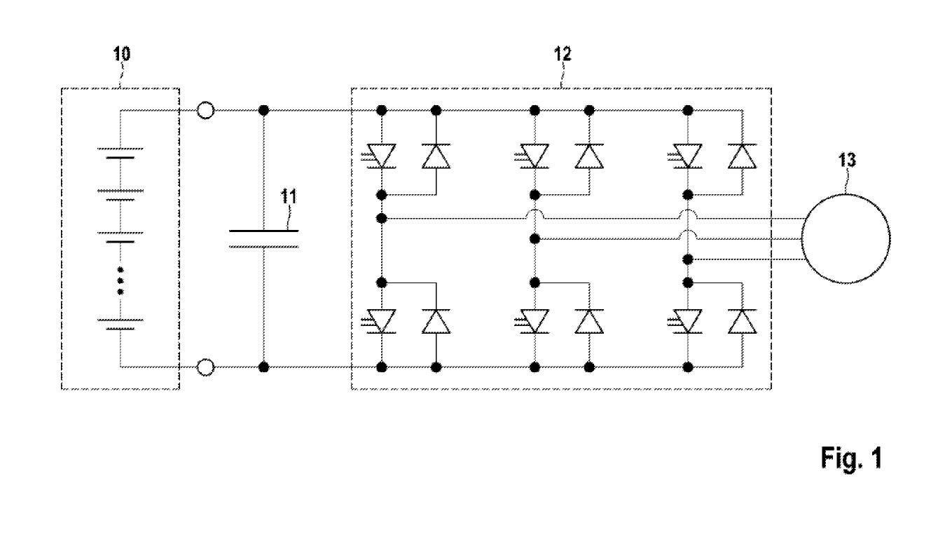

### EMBODIMENTS OF THE INVENTION

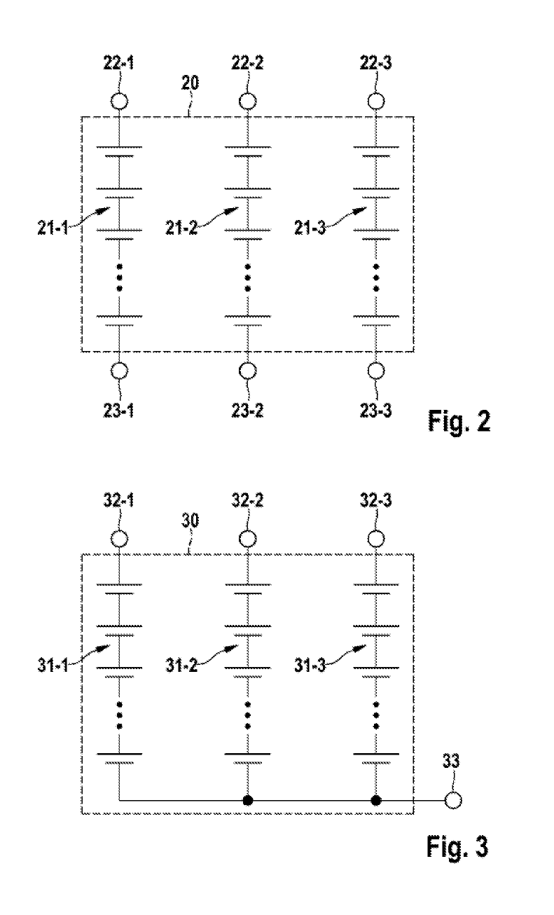

FIG. 2 shows a first exemplary embodiment of the invention. The battery 20 of the first exemplary embodiment has three battery cell lines 21-1, 21-2 and 21-3 which each have the same number of battery cells which are connected in series. Since no battery cell line 21-1, 21-2, 21-3 has a parallel connection of battery cells, it is impossible, despite a high overall capacity of the battery 20 which corresponds to three times an individual series circuit of battery cells, for compensating currents to occur between battery cells which are connected in parallel. Each of the battery cell lines 21-1, 21-2, 21-3 of the battery 20 has, in each case, a positive battery terminal 22-1, 22-2 or 22-3 and, in each case, a negative battery terminal 23-1, 23-2 or 23-3.

FIG. 3 shows a second exemplary embodiment of the invention. The battery 30 corresponds essentially to the battery 20 and has, like the latter, three battery cell lines 31-1, 31-2 and 31-3. Each of the battery cell lines has a respective positive battery terminal 32-1, 32-3 and 32-3, respectively. In the second exemplary embodiment of the invention, the negative poles of the battery cell lines 31-1, 31-2 and 31-3 are conductively connected to one another, for which reason only one negative battery terminal 33 is also provided.

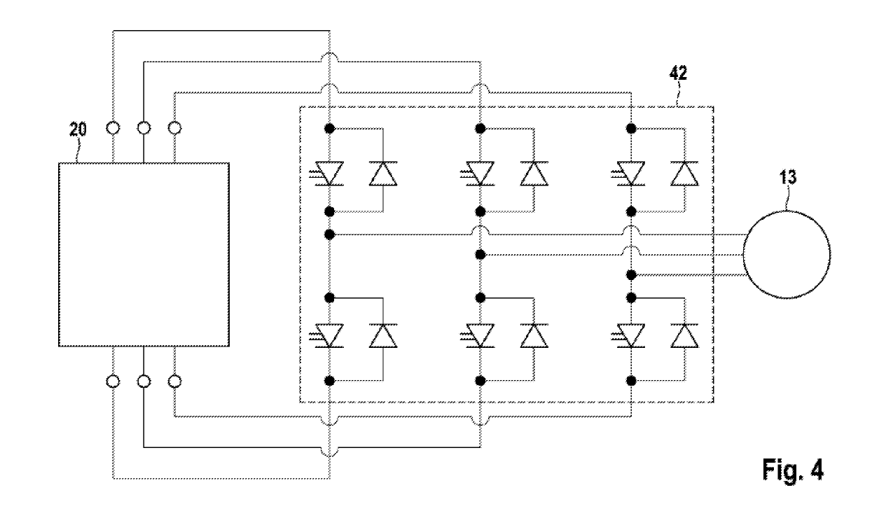

FIG. 4 shows an electric drive system having a battery 20 according to the invention. A pulse-controlled inverter 42 is directly connected, i.e. without connection for one or more capacitors at its inputs, to the three pairs of battery terminals of the battery 20. The pulse-controlled inverter 42 has a separate pair of inputs for each switching path with, in each case, two semiconductor valves and two diodes, which inputs are connected to, in each case, one of the three pairs of battery terminals of the battery 20. As a result, the direct voltage intermediate circuit is eliminated or three individual direct voltage intermediate circuits are provided. Owing to the relatively low power which is respectively extracted from the individual switching paths of the pulse-controlled inverter 42 of the battery and thus from the direct voltage intermediate circuit, the buffering of the direct voltage intermediate circuits can be performed by relatively small capacitors or dispensed with, as in the example in FIG. 4. The three switching paths of the pulse-controlled inverter 42 are connected on the output side to the three phase terminals of the electric drive motor 13.

1. A battery having comprising:
a plurality of battery cell lines, each battery cell line of the plurality of battery cell lines including a plurality of battery cells which are connected in series between a respective first pole and a respective second pole.

2. The battery as claimed in claim 1, wherein the battery includes three of the battery cell lines.

3. The battery as claimed in claim 1, wherein each first pole of the plurality of battery cell lines is conductively connected to a respective first battery terminal.

4. The battery as claimed in claim 1, wherein the second poles of the battery cell lines are conductively connected to one another.

5. The battery as claimed in claim 4, wherein the second poles of the battery cell lines are conductively connected to a second battery terminal.

6. The battery as claimed in claim 1, wherein every second pole of the plurality of battery cell lines is conductively connected to a respective second battery terminal.

7. The battery as claimed in claim 1, wherein:
the first poles of the plurality of battery cell lines are positive battery poles, and
the second poles of the plurality of battery cell lines are negative battery poles.

8. The battery as claimed in claim 1, wherein each battery cell of the plurality of battery cells is a lithium-ion battery cell.

9. The battery as claimed in claim 1, further comprising:
a battery housing in which the plurality of battery cell lines is arranged.

10. A motor vehicle comprising:
an electric drive motor configured to drive the motor vehicle; and
a battery connected to the electric drive motor, the battery including a plurality of battery cell lines, each battery cell line of the plurality of battery cell lines including a plurality of battery cells which are connected in series between a respective first pole and a respective second pole.
